(19) United States
(12) Patent Application Publication
(10) Pub. No.: US 2006/0256546 A1
(43) Pub. Date: Nov. 16, 2006

(54) Bag having safety features

(76) Inventor: Alicia Amaral, Hillsborough, NJ (US)

Correspondence Address: MATHEWS, SHEPHERD, MCKAY, & BRUNEAU, P.A., 29 THANT ROAD, SUITE 201, PRINCETON, NJ, 08540, US

(21) Appl. No.: 11/128,882

(22) Filed: May 13, 2005

(51) Int. Cl. F21V 21/08

(52) U.S. Cl. 362/103

(57) ABSTRACT

The present invention relates to a bag including a removable penlight flashlight for providing adequate lighting of a path in front of a bag. The bag comprises a pair of handles at a top thereof, one or more of the handles comprises a cavity for receiving the penlight flashlight. The bag and handles can be formed of light-weight nylon. An expandable section can be formed in the bottom of the bag such that in an extended condition the area within the bag is enlarged. Reflective stitching can be formed on one or more of a top edge or a side edge of the bag. A magnetic closure can be used to close the bag.

### BACKGROUND OF THE INVENTION

1. Field of the Invention

The invention relates to a bag having safety features, such as for trick or treating, in which a removable flashlight can be received in a handle of the bag for providing adequate lighting onto a path external of the bag and reflective stitching or reflective panels can be used on the bag for providing visibility of the bag.

2. Description of Related Art

Illuminated bags have been used to enhance visibility of a person carrying a bag during trick or treating.

U.S. Pat. No. 6,431,724 describes a bag having a glow stick incorporated in the hem of the bag. The glow stick is a chemiluminescence source.

U.S. Pat. No. 6,776,501 describes an illuminating handle/strap including holes punched through a clear strap to hold light emitting diodes in series.

U.S. Pat. No. 6,224,234 describes a hollow carrier having a body with a first opening in a top portion to allow treats to be opened and removed. The body has a second hole in a bottom portion. A diffuser and light source are received in the body's second hole.

The above-described embodiments either do not provide adequate lighting or are cumbersome to replace the light source. It is desirable to provide an improved bag having safety features that provide adequate lighting of a path and with a light source that is easily replaced.

### SUMMARY OF THE INVENTION

The present invention relates to a bag including a removable penlight flashlight for providing adequate lighting of a path in front of a bag. The bag comprises a pair of handles at a top thereof. One or more of the handles comprises a cavity for receiving the penlight flashlight. The bag and handles can be formed of light-weight nylon.

An expandable section can be formed in the bottom of the bag such that in an extended condition the area within the bag is enlarged. For example, during trick or treating or shopping, it is often desirable to add more items to an enlarged capacity of the bag.

The shape of the expandable section allows the bag to be increased in capacity without becoming too large to be used by children. Reflective stitching or reflective panels can be formed on one or more of a top edge or a side edge of the bag. A magnetic closure can be used to close the bag.

The invention will be more fully described by reference to the following drawings.

### BRIEF DESCRIPTION OF THE DRAWINGS

FIG. 1A is a perspective view of a bag having safety features in accordance with the teachings of the present invention.

FIG. 1B is a perspective view of a bag having safety features in a expanded position.

FIG. 2 is a schematic view of a handle used with the bag.

FIG. 3A is a perspective view of a front and side of the bag shown in FIG. 1A.

FIG. 3B is a perspective view of a front and side of the bag shown in FIG. 1B.

FIG. 4A is a top plan view of the bag.

FIG. 4B is a bottom plan view of the bag.

FIG. 5 is a perspective view of an alternate embodiment of the present invention in an expanded position.

FIG. 6 is a perspective view of a pouch attached to the bag.

### DETAILED DESCRIPTION

Reference will now be made in greater detail to a preferred embodiment of the invention, an example of which is illustrated in the accompanying drawings. Wherever possible, the same reference numerals will be used throughout the drawings and the description to refer to the same or like parts.

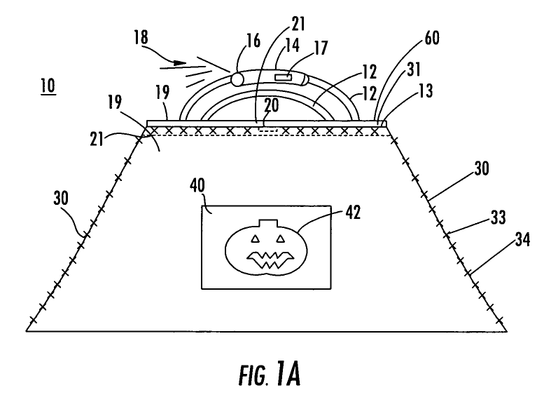

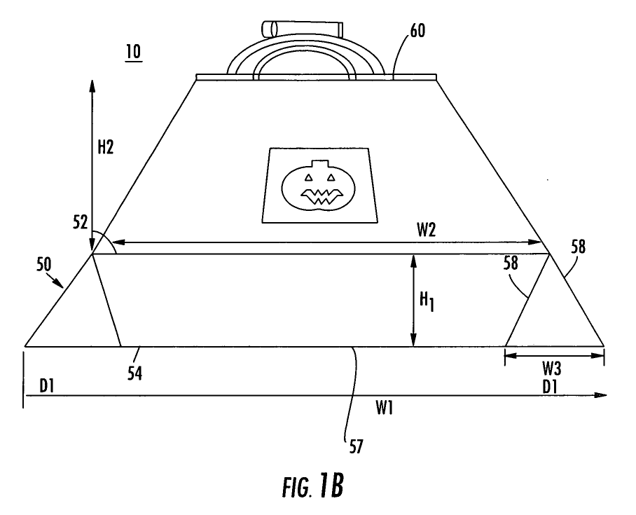

FIG. 1A is a perspective view of bag 10 in accordance with the teachings of the present invention. Bag 10 can be formed of a light weight material. For example, bag 10 can be formed of light weight nylon. Bag 10 can be formed of a washable material.

Handles 12 are positioned at top 13 of bag 10. Handles 12 can be integral with bag 10. Alternatively, handles 12 can be attached to top 13 of bag 10, by sewing or snap fasteners on any other conventional fastening means known in the art. Handles 12 can be formed of the same material as bag 10. Alternatively, handles 12 can be formed of a material different than bag 10, such as rigid plastic or flexible plastic.

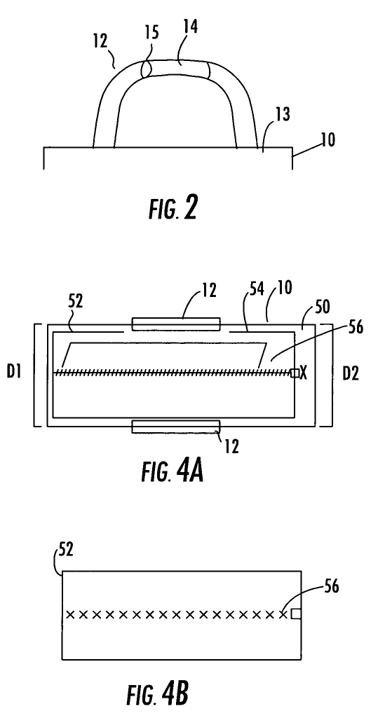

One or more of handles 12 can include cavity 14, as shown in FIG. 2. Cavity 14 includes opening 15 for receiving a removable penlight flashlight 16. Opening 15 has slightly larger dimensions than pen light flashlight 16 for holding penlight flashlight 16 in place after insertion.

Referring to FIG. 1A, penlight flashlight 16 includes self-contained power source 17, such as batteries. Penlight flashlight 16 can be activated before insertion into cavity 14. Upon activation and insertion of penlight flashlight 16 in cavity 14, area 18 in front of penlight flashlight 16 is illuminated. During use of bag 10 while trick or treating, a path of the carrier of bag 10 can be illuminated by area 18.

Top 13 of each of sides 19 of bag 10 can include magnetic closure means 20. For example, magnetic closure means 20 can include a magnetic fastener attached inside surface 21 of sides 19. Upon bringing handles 12 together, magnetic closure means 20 attached to each of sides 19 are attracted to one another to close bag 10. Elastic 17 can be sewn on within top 13 of sides of bag for closing bag 10.

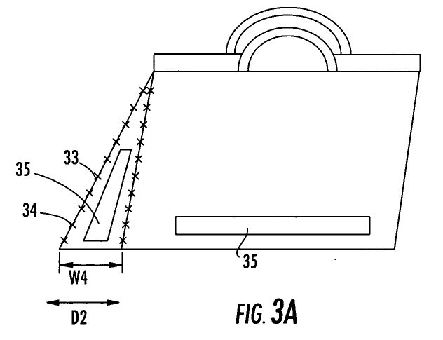

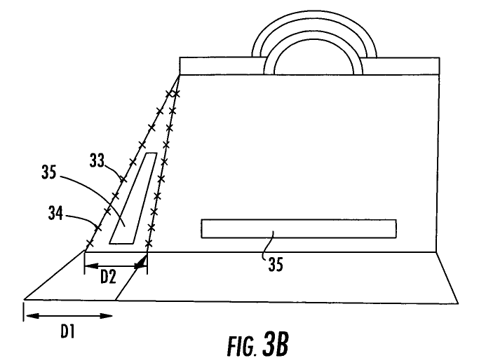

Reflective stitching 30 can be formed along one or more of top edge 31 at top 13 of bag 10 or side edges 33 at sides 34 of bag 10. Reflective stitching 30 can be formed of a reflective or glow-in-the-dark thread or yarn. Example colors of reflective stitching 30 include silver, fluorescent red-orange, fluorescent pink, fluorescent green or fluorescent yellow. Alternatively or in combination with reflective stitching 30, reflective panel 35 can be attached to one or more portions of bag 10, as shown in FIG. 3. Reflective stitching 30 and reflective panel 35 provide visibility of bag 10 during use. Sides 34 can be tapered from bottom 52 to top edge 31.

Transparent pouch 40 can be positioned on one or more of sides 34 of bag 10. Transparent pouch 40 can be formed of a transparent plastic or polymeric material. Decorative images 42 can be adhered to or formed on or within transparent pouch 40. For example, decorative images 42 can be related to Halloween.

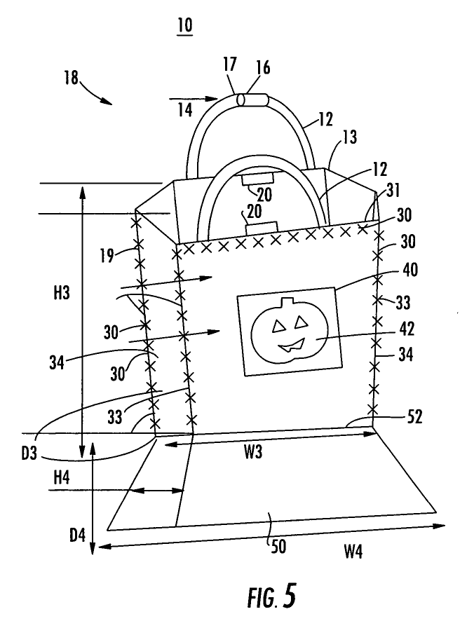

In one embodiment, bag 10 can include expandable section 50 at bottom 52 of bag 10 as shown in FIG. 1B. Expandable section 50 comprises pouch 54 which can be folded to lay flat on bottom 52 of bag 10 or rolled to lay on bottom 52 of bag 10, as shown in FIGS. 4A and 4B. During use, zipper 56 found in bottom 52 of bag 10 is unzipped allowing pouch 54 to extend beyond bag 10. For example, zipper 56 can be a dual reversible zipper. Pouch 54 includes base 57 and sides 58. Base 57 has a width W₁ which is larger than width W₂ of bag 10. Sides 58 have a width W₃ which is greater than width W₄ of sides 34 of bag 10, as shown in FIG. 1B and FIG. 3B. Pouch 54 can have a gusset shape. The arrangement of pouch 54 allows the capacity of bag 10 to be increased in size without increasing the size of bag 10 in the same proportion. For example, pouch 54 can allow the capacity of bag 10 to be doubled without doubling the height H₂ of bag 10. Pouch 54 has a height H₁ for providing extra storage space of bag 10. For example, bag 10 can have dimensions of width W₂ of about 12 inches, depth D₂ of about 7 inches and height H₂ of about 14 inches. Pouch 54 can have width W₁ of about 16 inches, depth D₁ of about 10.0 inches and height H₁ of about 4 inches. Accordingly, after extension of pouch 54, bag 10 has a height of about 18 inches.

In an alternate embodiment, bag 10 can have dimensions of width W₃ of about 10 inches depth D₃ of about 5 inches and height H₃ of about 10 inches in a tote bag configuration, as shown in FIG. 4. Pouch 54 can have width W₄ of about 14 inches, depth D₄ of about 10 inches and height H₄ of about 3 inches. According, after extension of pouch 54, bag 10 has a height of about 13 inches. In one embodiment, pouch 54 is used to receive additional treats received during trick or treating.

In one embodiment, bag 10 is reversible with the configuration of FIG. 1A and the configuration of FIG. 1B by turning inside 60 of bag 10 to the outside. In one embodiment, after expansion of expandable section 50, zipper 56 can be closed for separating portions of bag 10. For example, one portion of bag 10 can be used for dirty clothes and a second portion of bag 10 can be used for clean clothes. It will be appreciated that various objects can be received in bag 10.

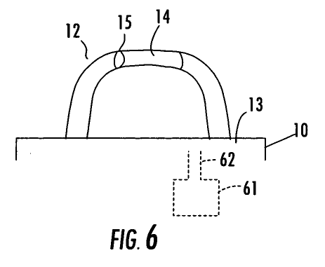

In one embodiment, item pouch 61 is attached to inside 60 of bag 10 with tether 62, as shown in FIG. 6. Item pouch 61 can have dimensions for receiving a cell phone. Upon reversing of inside 60 of bag 10 to the outside, tether 62 can be removed from the outside of bag 10 and placed within bag 10.

It is to be understood that the above-described embodiments are illustrative of only a few of the many possible specific embodiments, which can represent applications of the principles of the invention. Numerous and varied other arrangements can be readily devised in accordance with these principles by those skilled in the art without departing from the spirit and scope of the invention.

What is claimed is:

1. A bag comprising:
a pair of handles positioned at a top of said bag on either side of said bag, at least one or more of said handles including a cavity; and
a penlight flashlight removably received in said cavity,
wherein a path in front of said bag is illuminated by said penlight flashlight.

2. The bag of claim 1 wherein said cavity has slightly larger dimensions than said penlight flashlight.

3. The bag of claim 1 wherein said bag and said handles are formed of a light-weight nylon.

4. The bag of claim 1 wherein said bag is formed of a light-weight nylon and said handles are formed of rigid plastic or flexible plastic.

5. The bag of claim 1 further comprising:
reflective stitching formed along one or more of a top edge at said top of said bag or a side edge at said side of said bag.

6. The bag of claim 5 wherein said reflective stitching is formed of a reflective or glow-in-the-dark thread.

7. The bag of claim 1 further comprising:
one or more reflective panels coupled to a side of said bag.

8. The bag of claim 7 wherein said one or more reflective panels are formed of a reflective or glow-in-the-dark material.

9. The bag of claim 1 further comprising:
a transparent pouch positioned on one or more of said sides of said bag.

10. The bag of claim 1 further comprising:
an expandable section formed at a bottom of said bag.

11. The bag of claim 10 wherein said expandable section comprises a pouch having a larger width than as said bag.

12. The bag of claim 11 wherein said pouch is tapered from said width of said pouch to said width of said bag.

13. The bag of claim 11 further comprising:
a zipper in said bottom of said bag,
wherein said zipper can be unzipped to allow said pouch to extend from said bag.

14. The bag of claim 11 wherein said pouch has a gusset shape.

15. The bag of claim 10 wherein capacity of said bag and said expandable section is doubled compared to capacity of said bag.

16. The bag of claim 13 wherein said zipper is a dual reversible sipper.

17. The bag of claim 16 wherein said bag is reversible.

18. The bag of claim 11 wherein said bag can have dimensions of width W₁ of about 12 inches, depth D₁ of about 7 inches and height H₁ of about 14 inches and said pouch can have dimensions of width W₂ of about 12 inches, depth D₂ of about 7 inches and height H₂ of about 4 inches.

19. The bag of claim 11 wherein said bag can have dimensions of width W₃ of about 10 inches, depth D₃ of about 5 inches and height H₃ of about 10 inches and said pouch can have dimensions of width W₄ of about 10 inches, depth D₄ of about 10 inches and height H₄ of about 3 inches.

20. The bag of claim 1 further comprising:
magnetic closure means positioned at said top of said bag on each of said sides,
wherein upon bringing said handles together said magnetic closure means attached to said sides of said bag are attracted to one another to close said bag.

21. The bag of claim 1 wherein said bag and said handles are formed of a washable material.
